(19) United States
(12) Patent Application Publication
(10) Pub. No.: US 2018/0240368 A1
(43) Pub. Date: Aug. 23, 2018

(54) GARMENT ORGANIZATION AND IDENTIFICATION APPARATUS AND METHOD

(71) Applicant: Gregory P. Bohk, SR., Greenlawn, NY (US)

(72) Inventor: Gregory P. Bohk, SR., Greenlawn, NY (US)

(21) Appl. No.: 15/653,979

(22) Filed: Jul. 19, 2017

Related U.S. Application Data
(60) Provisional application No. 62/461,587, filed on Feb. 21, 2017.

(51) Int. Cl. G09F 3/02; B43L 1/00; G09F 3/08

(52) U.S. Cl. CPC G09F 3/02; G09F 3/08; B43L 1/00

(57) ABSTRACT

An apparatus and methods for wardrobe management which permit the user to reusable organize a hanging wardrobe in a convenient and effective manner. The apparatus and methods, incorporate a planar card having a first surface opposing a second and a reusable writing material disposed over at least a portion of at least one of the first or second surfaces of the planar card. An aperture is disposed within the planar card and configured to receive a clothing hanger loop of a clothing hanger. At least a portion of the planar card is visible when the clothing hanger loop is fully inserted into the aperture and the clothing hanger is placed on a hanging rack.

### CROSS-REFERENCE TO RELATED APPLICATION

This application claims priority to U.S. Provisional Patent Application Ser. No. 62/461,587 filed Feb. 21, 2017, the entirety of which is incorporated herein by reference.

### FIELD

The present disclosure generally relates to the technical field of organization and identification tools and methods. More specifically, the present disclosure is directed to a wardrobe management, organization and identification apparatus and method for clothing.

### DESCRIPTION OF THE RELATED ART

Traditional clothing organizational tools and devices are limited in design and utility for various retail and consumer applications. For clothing items placed on a hanger, current identification methods are limited to temporary tags placed on the respective clothing item or the hanger. Temporary tags may include pre-printed paper identification tags placed on the hanger or hanger cover (e.g., paper hanger cover, hanger garment bag, etc.). In some instances, pre-printed paper identification tags may be disposed on the tag of the clothing item. Pre-printed paper identification tags used for clothing organization and identification are not conducive to grouping multiple wardrobe items together. In addition, in settings where multiple wardrobe items are placed on respective hangers, paper identification tags are often obstructed from view complicating organization and management efforts.

In addition, current wardrobe management and identification methods that use manufactured labels to identify specific information are typically unrelated to consumer's organizational needs. Traditional methods of closet hanging wardrobe organization may include placing a manufactured label directly on the bar or rack used for holding the hangers. However, these methods are limited in utility and function because the identification means (e.g., tags, labels, etc.) are limited in size and are pre-printed with information that prevents identifying wardrobe items with specificity. The inability to customize traditional management and identification means limits the reusability of these items for consumers.

Hanging wardrobe management and identification prior art tools and methods do not meet the current needs of consumers and businesses. These tools and methods are of limited utility for consumers and retailers who desire a reusable and customizable means of managing and organizing a wardrobe. Additionally, the inventor has identified a manufacturing process for wardrobe management tools that addresses the issue of including background art or words on a reusable writing surface material while maximizing the writeable surface area. The novel manufacturing process described herein is significant because the writing surface is so small, and the manufacturing process permits artwork or branding over the entire writing surface while maintaining the usability of the entire writing surface

### SUMMARY OF THE INVENTION

In various embodiments of the present disclosure, a wardrobe management tool is provided including a planar card having a first surface opposing a second surface, a reusable writing material disposed over at least a portion of at least one of the first or second surfaces, an aperture within the planar card configured to receive a clothing hanger loop of a clothing hanger. At least a portion of the planar card is visible when the clothing hanger loop is fully inserted into the aperture and the clothing hanger is placed on a hanging rack.

In various embodiments, a wardrobe management tool is provided including a planar card having a first surface opposing a second surface formed from a flexible plastic polymer or elastomer, a reusable writing material disposed over at least a portion of the first and second surface of the planar card, a first aperture within the planar card configured to receive a plurality of clothing hanger loop ends, and a latching device having a first and second end configured to secure the planar card using the latching device first end to a bar configured to receive a plurality of clothing hanger loop ends, when a clothing hanger loop end is not disposed within the aperture. At least a portion of the planar card is visible when at least one clothing hanger loop end of a clothing hanger is fully inserted into the aperture and the at least one clothing hanger loop end is placed on a hanging bar configured to receive a plurality of clothing hanger loop ends.

In various embodiments of the present disclosure, a method of organizing a wardrobe of garments disposed on a plurality of respective clothing hangers is provided, comprising the steps of: writing using a marker on a reusable writing material disposed over at least a portion of a planar card surface having a first surface opposing a second surface; inserting a respective clothing hanger loop end having a garment into an aperture disposed within the planar card, wherein the aperture is configured to receive a plurality of clothing hanger loop ends; and placing the respective clothing hanger loop end on a clothing bar configured to receive a plurality of clothing hanger loop ends, wherein at least a portion of the planar card first and second surface is visible when the clothing hanger loop end is placed on the clothing bar.

The foregoing and additional aspects and embodiments of the present invention will be apparent to those of ordinary skill in the art in view of the detailed description of various embodiments and/or aspects, which is made with reference to the drawings, a brief description of which is provided next.

### BRIEF DESCRIPTION OF THE DRAWINGS

Various aspects of the present disclosure will be or become apparent to one with skill in the art by reference to the following detailed description when considered in connection with the accompanying exemplary non-limiting embodiments, in which:

FIG. 1 is a front side view of a wardrobe management tool in accordance with some embodiments of the present disclosure.

FIG. 2 is a front side view of a wardrobe management tool in accordance with some embodiments of the present disclosure.

FIG. 3A is a front side view of a wardrobe management tool disposed on a hanger in accordance with some embodiments of the present disclosure.

FIG. 3B is a back side view of a wardrobe management tool disposed on a hanger in accordance with some embodiments of the present disclosure.

FIG. 4 is a front side view of a wardrobe management tool in a horizontal position disposed on a plurality of hanger loop ends in accordance with some embodiments of the present disclosure.

FIG. 5A is a front side view of a wardrobe management tool disposed on a hanger bar in accordance with some embodiments of the present disclosure.

FIG. 5B is a front side view of a wardrobe management tool disposed on a hanger bar in accordance with some embodiments of the present disclosure.

While the present disclosure is susceptible to various modifications and alternative forms, specific embodiments have been shown by way of example in the drawings and will be described in detail herein. It should be understood, however that the present disclosure is not intended to be limited to the particular forms disclosed. Rather, the present disclosure is to cover all modifications, equivalents, and alternatives with the spirit and scope of the disclosure as defined by the appended claims.

### DETAILED DESCRIPTION

With reference to the figures, where like elements have been given like numerical designations to facilitate an understanding of the drawings, various embodiments of an apparatus for a wardrobe management tool are described. The figures are not drawn to scale.

This description of the exemplary embodiments is intended to be read in connection with the accompanying drawings, which are to be considered part of the entire written description. The use of the singular includes the plural unless specifically stated otherwise. The use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, the section headings used herein are for organizational purposes only, and are not to be construed as limiting the subject matter described.

The following description is provided as an enabling teaching of a representative set of examples. Many changes can be made to the embodiments described herein while still obtaining beneficial results. Some of the desired benefits discussed below can be obtained by selecting some of the features discussed herein without utilizing other features. Accordingly, many modifications and adaptations, as well as subsets of the features described herein are possible and can even be desirable in certain circumstances. Thus, the following description is provided as illustrative and is not limiting.

This description of illustrative embodiments is intended to be read in connection with the accompanying drawings, which are to be considered part of the entire written description. The drawing figures are not necessarily to scale and certain features of the invention can be shown exaggerated in scale or in somewhat schematic form in the interest of clarity and conciseness. In the description of embodiments disclosed herein, any reference to direction or orientation is merely intended for convenience of description and is not intended in any way to limit the scope of the present disclosure. Relative terms such as “horizontal,” “vertical,” “up,” “down,” “top,” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral,” and the like are to be interpreted relative to one another or relative to an axis of elongation, or an axis or center of rotation, as appropriate. Terms concerning attachments, coupling, and the like, such as “connected” “interconnected,” “attached” and “affixed,” refer to a relationship wherein structures are secured or attached to one another either directly or indirectly through intervening structures, as well as both movable or rigid attachments or relationships, unless expressly described otherwise. The terms “operatively connected” or “operatively coupled” are such an attachment, coupling or connection that allows the pertinent structures to operate as intended by virtue of that relationship. The term “adjacent” as used herein to describe the relationship between structures/components includes both direct contact between the respective structures/components referenced and the presence of other intervening structures/components between respective structures/components.

As used herein, use of a singular article such as “a,” “an” and “the” is not intended to exclude pluralities of the article's object unless the context clearly and unambiguously dictates otherwise.

The inventor has developed an apparatus for use as a wardrobe management, organization, and identification tool in a hanging closet or retail environment. The wardrobe management apparatus permits the user to organize and manage wardrobe items disposed on a hanger. For example, the inventors have determined that the apparatus provided herein is able to organize individual wardrobe items or a plurality of wardrobe items disposed on a respective hanger with specificity.

Additionally, by way of example, the inventors have determined that the apparatus described herein provides a convenient, effective, reusable solution for garment and wardrobe management in both home and commercial environments.

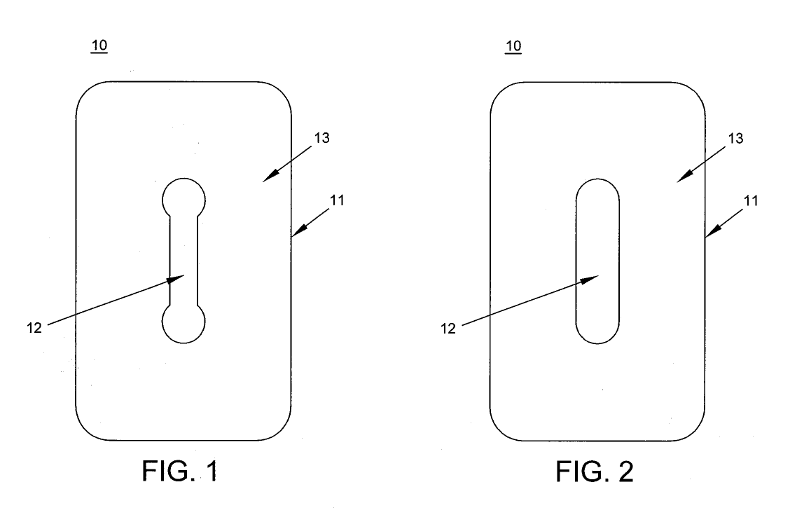

FIG. 1 is a front side view of a wardrobe management tool 10 in accordance with some embodiments of the present disclosure. As shown in FIG. 1, wardrobe management tool 10 comprises a planar card 11 having a first surface opposing a second surface and an aperture 12 disposed within the body of planar card 11. In various embodiments, planar card 11 of wardrobe management tool 10 may be formed from a semi rigid material (e.g., plastic, vinyl, etc.). In some embodiments, planar card 11 may be formed from CONCEPT 400® Gloss UV Overlaminating Film, PRIMEX PLASTICS PRIME IMPAX POLYSTYRENE SHEET™, and/or a similar polyvinyl chloride (PVC) or polystyrene material as would be understood by one of ordinary skill in the art. Planar card 11 may be formed by disposing a CONCEPT 400® Gloss UV Overlaminating Film or similar material over each planar side of a PRIMEX PLASTICS PRIME IMPAX POLYSTYRENE SHEET™ or similar material.

In some embodiments, wardrobe management tool 10 is formed from a manufacturing process comprising the steps of digital printing on a semi rigid material, precision laminating the semi rigid material, and digitally cutting the laminated semi rigid material. Digital printing on the semi rigid material before precision laminating advantageously provides for an increased writeable surface area on a reusable writing material surface. For example, if artwork is printed to the laminating surface, the writeable surface is decreased because the properties creating the reusable writing material are different in areas where the artwork is printed. As will be appreciated, for smaller applications as described herein, reducing the writeable surface area on a reusable writing material decreases the overall utility of the wardrobe management tool 10. Thus, in some embodiments, digital printing occurs before laminating in the manufacturing process described above to increase the effective writing surface area of the reusable writing material. In various embodiments, all of the peripheral edges of wardrobe management tool 10 are rounded or smooth to the touch.

In various embodiments, planar card 11 of wardrobe management tool 10 is substantially flat with a thickness of approximately three millimeters (e.g., between one and five millimeters). In some embodiments, planar card 11 is configured to be flexible with the ability to bend and return to a substantially flat shape. The outer peripheral edges of planar card 11 may form a substantially rectangular shape. In some embodiments, the corners of the outer peripheral edge of planar card 11 are rounded or smooth and configured to prevent snagging and damaging delicate fabrics. In various embodiments, the outer peripheral edge of planar card 11 may comprise chrome edging or piping.

FIG. 2 is a front side view of a wardrobe management tool 10 in accordance with some embodiments of the present disclosure. According to various embodiments, an aperture 12 is disposed within planar card 11 and configured to receive a plurality of clothing hanger loop ends 14. In some embodiments, as illustrated in FIG. 1, aperture 12 disposed within planar card 11 may comprise bulbous circular ends disposed on opposite sides of an elongated track having a width less than the diameter of the bulbous circular ends (e.g., “dogbone” shape). In various embodiments, as illustrated in FIG. 2, aperture 12 may comprise semi-circular ends disposed on opposite sides of an elongated track having a width equal to the diameter of the semi-circular ends. It should be appreciated, the size and shape of aperture 12 may have various dimensions configured to receive a plurality of various style hangers (e.g., wire type, plastic, wood, etc.) as would be understood by one of ordinary skill in the art.

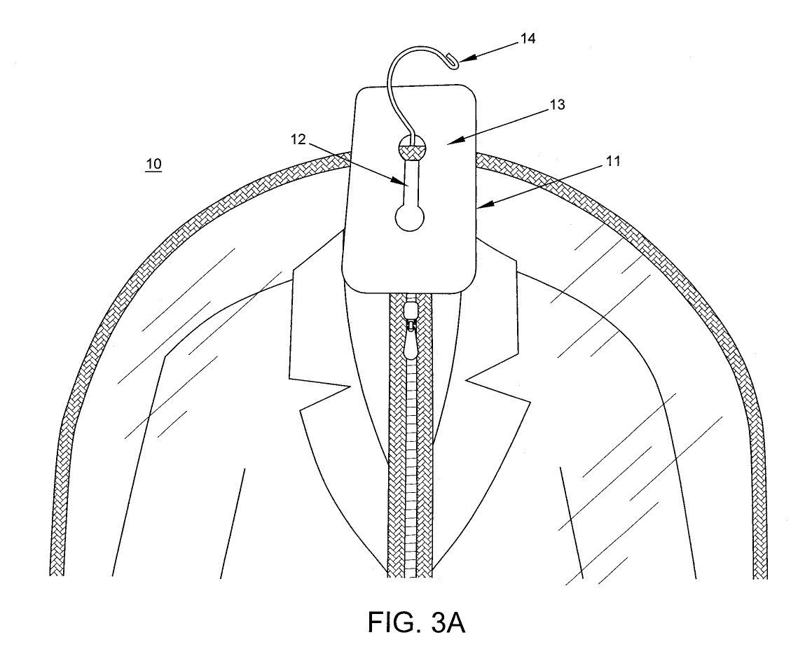

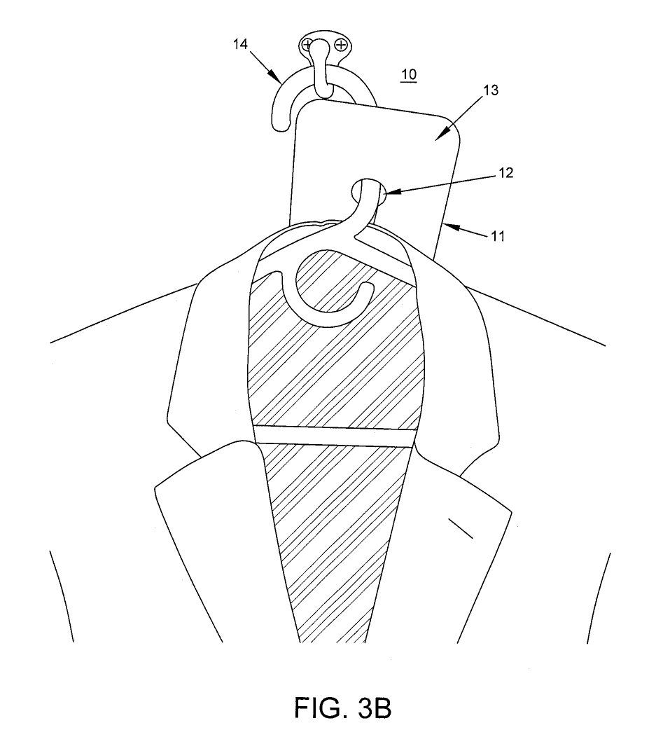

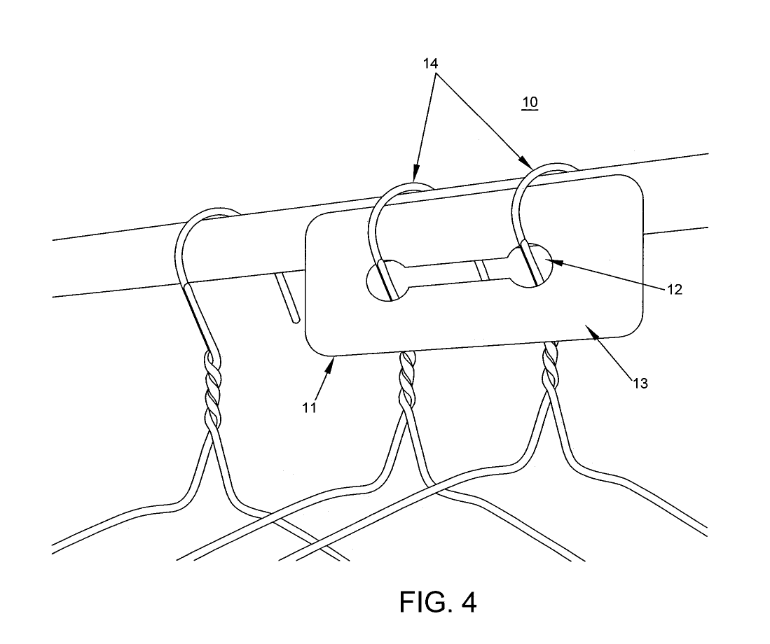

FIG. 3A is a front side view of a wardrobe management tool 10 disposed on a hanger in accordance with some embodiments of the present disclosure. FIG. 3B is a back side view of a wardrobe management tool 10 disposed on a hanger in accordance with some embodiments of the present disclosure. According to various embodiments, wardrobe management tool 10 is configured to receive the hanger loop end 14 of a hanger via aperture 12. In some embodiments, as illustrated in FIG. 3A-3B, aperture 12 is configured to receive a hanger loop end 14 of a hanger such that a planar side of wardrobe management tool 10 is substantially parallel with the plane of the hanger body. In some embodiments, aperture 12 is configured to receive a hanger loop end 14 of a hanger such that the planar side of the wardrobe management tool 10 is substantially perpendicular with the plane of the hanger body and rests on the hanger body end. In various embodiments, wardrobe management tool 10 is substantially vertical when disposed on hanger loop end 14, as shown in FIGS. 3A-3B.

FIG. 4 is a front side view of a wardrobe management tool 10 in a horizontal position disposed on a plurality of hanger loop ends 14 in accordance with some embodiments of the present disclosure. In some embodiments, aperture 12 of wardrobe management tool 10 is configured to receive a plurality of hanger loop ends 14. Aperture 12 may be configured to receive a plurality of hanger loop ends 14 of different sizes and material (e.g., wooden, plastic, wire-type, etc.). In various embodiments, as illustrated in FIG. 4, wardrobe management tool 10 is configured to be disposed in a horizontal position between a hanger loop end 14 and a hanger bar 16 or rack when at least two or more hanger loop ends 14 are disposed within aperture 12.

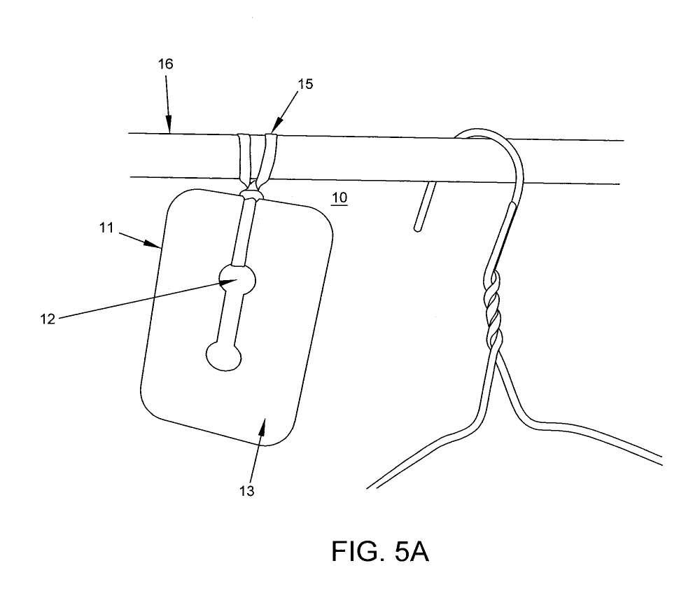

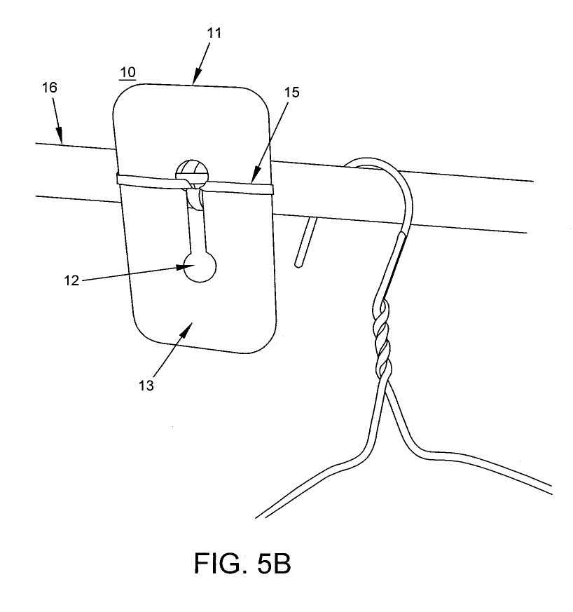

FIG. 5A is a front side view of a wardrobe management tool 10 disposed on a hanger bar 16 in accordance with some embodiments of the present disclosure. FIG. 5B is a front side view of a wardrobe management tool 10 disposed on a hanger bar 16 in accordance with some embodiments of the present disclosure. In various embodiments, aperture 12 of wardrobe management tool 10 is configured to receive a latching device 15 for securing wardrobe management tool 10 to a hanger bar 16. In some embodiments, latching device 15 is configured to secure the wardrobe management tool 10 to a hanger bar 16 in a horizontal or vertical position. In various embodiments, planar card 11 is configured to receive a latching device 15 in an additional aperture (not shown) for securing the wardrobe management tool 10. Wardrobe management tool 10 may comprise a magnet, adhesive, or similar attachment means for securing wardrobe management tool 10 to a hanger bar 16, as would be understood by one of ordinary skill in the art. In some embodiments, latching device 15 is configured to secure wardrobe management tool 10 to various objects and surfaces other than hanger bar 16 as would be understood by one of ordinary skill in the art for identification and management. In some embodiments, latching device 15 has elastic properties (e.g., a rubberband). It should be appreciated that latching device 15 may be any suitable material or configuration to secure wardrobe management tool 10 as would be understood by one of ordinary skill in the art.

In various embodiments of the present disclosure, a reusable writing material (e.g., dry erase, wet erase, etc.) or similar material is disposed over the outer planar surfaces 13 (e.g., front and back) of wardrobe management tool 10. By way of example, CONCEPT 400® Gloss UV Overlaminating Film may be disposed over the outer planar surfaces 13 configured to provide a dry erase or wet erase writing surface. In some embodiments, the reusable writing material is disposed over the entire outer planar surfaces 13. In various embodiments, the reusable writing material is disposed over a portion of the outer planar surfaces 13. In some embodiments, the reusable writing material may be formed from a melamine film, plastic, or other similar dry or wet erase (e.g., whiteboard) material as would be understood by one of ordinary skill in the art.

It may be emphasized that the above-described embodiments, are merely possible examples of implementations, and merely set forth a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and the present disclosure and protected by the following claims.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

While various embodiments have been described, it is to be understood that the embodiments described are illustrative only and that the scope of the subject matter is to be accorded a full range of equivalents, many variations and modifications naturally occurring to those of skill in the art from a perusal hereof.

1. A wardrobe management tool, comprising:
a planar card having a first surface opposing a second surface, wherein the planar card is formed from a flexible plastic polymer or elastomer having resuasable writing material properties;
at least one clothing hangar having a respective clothing hanger loop;
an aperture within the planar card configured to receive the respective clothing hanger loop of the at least one clothing hanger; and,
wherein at least a portion of the planar card is visible when the respective clothing hanger loop is fully inserted into the aperture and the clothing hanger is placed on a hanging rack.

2. The wardrobe management tool of claim 1, wherein the aperture is further configured to receive a plurality of clothing hanger loops associated with a plurality of respective clothing hangers.

3. (canceled)

4. The wardrobe management tool of claim 1, wherein the aperture is formed having bulbous circular ends disposed on opposite sides of an elongated track having a width less than the diameter of the bulbous circular ends, wherein the elongated track is configured to receive a plurality of clothing hanger loops associated with a plurality of respective clothing hangers.

5. The wardrobe management tool of claim 1, wherein the aperture is formed having semi-circular ends disposed on opposite sides of an elongated track having a width equal to the diameter of the semi-circular ends, wherein the elongated track is configured to receive a plurality of clothing hanger loops associated with a plurality of respective clothing hangers.

6. The wardrobe management tool of claim 1, wherein corners of the planar card outer peripheral edge are rounded.

7. The wardrobe management tool of claim 1, wherein the reusuable writing material is formed from a laminating film.

8. The wardrobe management tool of claim 1, wherein the outer peripheral edge of the planar card comprises chrome edging.

9. The wardrobe management tool of claim 1, wherein the reusuable writing material is formed from melamine.

10. The wardrobe management tool of claim 1, further comprising a latching device for securing the wardrobe management tool and a hanging rack, wherein the latching device is configured to secure the planar card to the hanging rack.

11. The wardrobe management tool of claim 10, wherein the aperture is further configured to receive the latching device.

12. A wardrobe management tool, comprising:
a planar card having a first surface opposing a second surface formed from a flexible plastic polymer or elastomer, wherein the flexible plastic polymer or elastomer has resusable writing material properties;
a first aperture within the planar card configured to receive a plurality of clothing hanger loop ends of respective clothing hangers;
and,
wherein at least a portion of the planar card is visible when at least one clothing hanger loop end of a clothing hanger is fully inserted into the aperture and the at least one clothing hanger loop end is placed on a hanging bar configured to receive a plurality of clothing hanger loop ends.

13. The wardrobe management tool of claim 12, further comprising a latching device having a first and second end configured to secure the planar card using the latching device first end to a bar configured to receive a plurality of clothing hanger loop ends, when a clothing hanger loop end is not disposed within the aperture, wherein the first aperture is further configured to receive the second end of the latching device.

14. The wardrobe management tool of claim 13, further comprising a second aperture configured to receive the second end of the latching device.

15. The wardrobe management tool of claim 12, wherein the planar card is on a plane that is substantially perpendicular to the plane of the respective clothing hangers loop ends, when a plurality of clothing hanger loop ends of the respective clothing hangers are fully inserted into the first aperture and the plurality of clothing hanger loop ends are placed on a hanging bar configured to receive a plurality of clothing hanger loop ends.

16. The wardrobe management tool of claim 12, wherein the latching device is a magnet.

17. The wardrobe management tool of claim 12, wherein corners of the planar card outer peripheral edge are rounded.

18. The wardrobe management tool of claim 12, wherein the aperture is formed having bulbous circular ends disposed on opposite sides of an elongated track having a width less than the diameter of the bulbous circular ends.

19. The wardrobe management tool of claim 12, wherein the aperture is formed having semi-circular ends disposed on opposite sides of an elongated track having a width equal to the diameter of the semi-circular ends.

20. A method for organizing a wardrobe of garments disposed on a plurality of respective clothing hangers, comprising the steps of:
writing using a marker on a reusable writing material disposed over at least a portion of a planar card surface having a first surface opposing a second surface and formed from an flexible plastic polymer or elastomer;
inserting a respective clothing hanger loop end having a garment into an aperture disposed within the planar card, wherein the aperture is configured to receive a plurality of clothing hanger loop ends; and,
placing the respective clothing hanger loop end on a clothing bar configured to receive a plurality of clothing hanger loop ends, wherein at least a portion of the planar card first and second surface is visible when the clothing hanger loop end is placed on the clothing bar.
